(19) United States
(12) Patent Application Publication
(10) Pub. No.: US 2026/0012849 A1
(43) Pub. Date: Jan. 8, 2026

(54) Method for Low-latency and Low-error Wireless Communication in a Dual Band Concurrent Connectivity Environment

(71) Applicant: NEXICONN TECHNOLOGY CORPORATION, Tokyo (JP)

(72) Inventor: Hsin-Wei Huang, Taipei City (TW)

(73) Assignee: NEXICONN TECHNOLOGY CORPORATION, Tokyo (JP)

(21) Appl. No.: 18/765,354

(22) Filed: Jul. 8, 2024

(51) Int. Cl. H04W 28/04; H04L 1/1607; H04W 28/02

(52) U.S. Cl. CPC H04W 28/04; H04L 1/1607; H04W 28/0284

(57) ABSTRACT

A wireless communication method in a Dual Band Concurrent Connectivity (DBCC) environment includes assigning a plurality of first channels as primary channels and a plurality of second channels as secondary channels when overall connectivity quality of the plurality of first channels is better than overall connectivity quality of the plurality of second channels, simultaneously transmitting critical data frames over the primary channels and the secondary channels, when data is to be transmitted with reduced communication errors, and the data is not critical, allocating the data to the primary channels and the secondary based on required communication error rates, and when data is to be transmitted without reduced communication errors, and the data is not critical, allocating the data to the primary channels and the secondary channels according to data types of the data.

### BACKGROUND OF THE INVENTION

### 1. Field of the Invention

The present invention is related to a method for low-latency and low-error wireless communication, in particular, a method for low-latency and low-error wireless communication in a dual band concurrent connectivity environment.

### 2. Description of the Prior Art

Low latency plays a crucial role in data transmission, especially in applications that require real-time interaction and responsiveness. Latency, which is the delay before data transfer begins after an instruction, is directly linked to service quality and user satisfaction. This importance is particularly evident in fields like live streaming, online gaming, virtual reality (VR), and wireless multimedia content delivery.

To ensure seamless user experiences in these applications, achieving and maintaining a latency of 10 milliseconds (ms) or less is crucial. However, current wireless technologies, including widely used standards like Miracast and Bluetooth, often face latencies ranging from 30 ms to 100 ms. These higher latencies significantly impact the quality of real-time interactions and multimedia enjoyment.

In the context of current live-streaming and real-time applications, established wireless transmission technologies like Bluetooth and Miracast play a crucial role in facilitating data transfer. However, these widely adopted technologies face significant challenges in maintaining data integrity, particularly in environments susceptible to interference and signal degradation.

To mitigate data loss, these technologies primarily rely on retransmitting lost packets. Specifically, Bluetooth's link layer and Miracast's use of the Wi-Fi Direct protocol initiate procedures to resend data until it's successfully received. While effective in recovering lost data, this approach significantly contributes to increased latency, resulting in delays ranging from 30 milliseconds (ms) to 100 ms. Unfortunately, such delays fall short of the ideal sub-10 ms latency required for optimal real-time interactions.

Although retransmission strategies enhance data transfer reliability, they inadvertently exacerbate latency. This latency not only impacts user experience in time-sensitive applications but also hinders the feasibility of implementing these technologies in scenarios that demand instantaneous feedback-such as competitive online gaming and high-quality live streaming. Consequently, there is a pressing need for the development of alternative wireless transmission technologies capable of achieving significantly lower latency, ideally below 10 milliseconds, without compromising data integrity.

Therefore, the need for innovation in minimizing wireless transmission latency becomes apparent. The present invention introduces novel methods and systems aimed at overcoming the limitations of current wireless technologies, resulting in a significant advancement toward achieving ultra-low latency across various real-time applications.

### SUMMARY OF THE INVENTION

An embodiment provides a wireless communication method in a Dual Band Concurrent Connectivity (DBCC) environment. The method includes assigning a plurality of first channels as primary channels and a plurality of second channels as secondary channels when overall connectivity quality of the plurality of first channels is better than overall connectivity quality of the plurality of second channels, simultaneously transmitting critical data frames over the primary channels and the secondary channels, when data is to be transmitted with reduced communication errors, and the data is not critical, allocating the data to the primary channels and the secondary channels based on required communication error rates, and when data is to be transmitted without reduced communication errors, and the data is not critical, allocating the data to the primary channels and the secondary channels according to data types of the data.

Another embodiment provides a transmission error detection method in a wireless communication system. The method includes monitoring back-off mechanism acknowledgement (BA) reports during data transmission, when an expected BA report is not received and a timeout is received, not determining a transmission error when has occurred, not receiving a predetermined number of expected BA reports consecutively while receiving the predetermined number of timeouts consecutively, determining a network is congested, and when a BA report is received after timeout, determining received data is outdated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a wireless communication method in a simultaneous DBCC environment according to an embodiment of the present invention.

FIG. 2 is a flowchart of a transmission error detection method in a wireless communication system according to an embodiment of the present invention.

FIG. 3 is a schematic diagram of the distribution_step method according to an embodiment of the present invention.

FIG. 4 is a schematic diagram of the distribution_step method according to another embodiment of the present invention.

### DETAILED DESCRIPTION

Dual Band Concurrent Connectivity (DBCC) is a feature that enables a wireless device or network to operate on both the 2.4 GHz and 5 GHz frequency bands at the same time. It can be implemented in two ways: simultaneous dual band and selectable dual band.

Simultaneous dual band allows for the creation of two separate Wi-Fi networks using both the 2.4 GHZ and 5 GHz bands concurrently. This approach effectively doubles the available bandwidth, providing a more robust Wi-Fi network for activities like video streaming and gaming. It also helps prevent overcrowding and interference when multiple devices are connected.

On the other hand, selectable dual band supports only one Wi-Fi network at a time, operating on either the 2.4 GHz or 5 GHz band. This is akin to having a single-band router with the flexibility to switch between two channels.

While simultaneous dual band offers enhanced performance and versatility, selectable dual band provides a simpler setup but with fewer options.

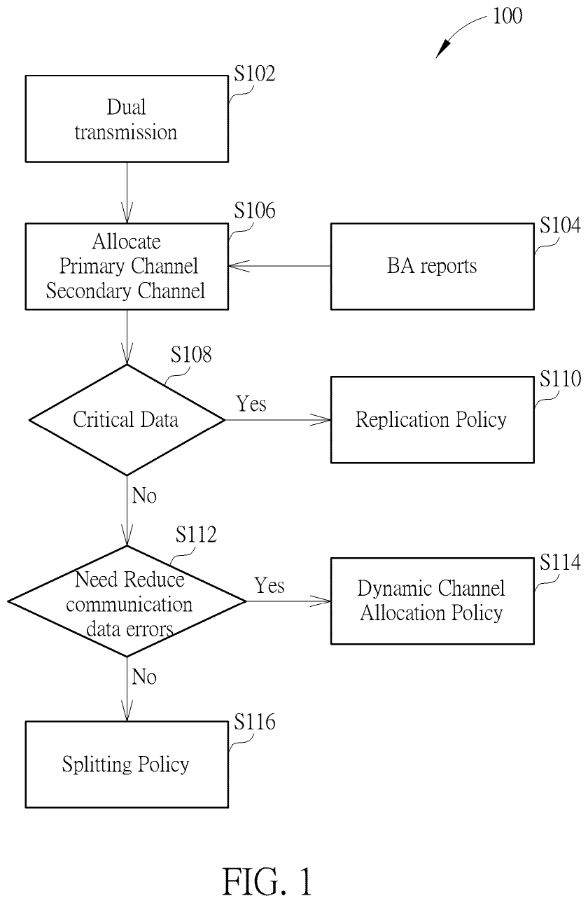

FIG. 1 is a flowchart of a wireless communication method 100 in a simultaneous DBCC environment according to an embodiment of the present invention. The wireless communication method includes the following steps:
Step S102: apply dual transmission with a plurality of first channels and a plurality of second channels in the DBCC environment; go to step S106;
Step S104: monitor back-off mechanism acknowledgement (BA) reports during data transmission;
Step S106: assign the plurality of first channels as primary channels and the plurality of second channels as secondary channels when overall connectivity quality of the plurality of first channels is better than overall connectivity quality of the plurality of second channels;
Step S108: check whether data to be transmitted is critical or not; if so, go to step S110; else, go to step S112;
Step S110: transmitting the data based on a replication policy.
Step S112: check whether communication data errors of the data to be transmitted need to be reduced; if so, go to step S114; else, go to step S116;
Step S114: transmitting the data based on a dynamic channel allocation policy.
Step S116: transmitting the data based on a splitting policy.

In step S102, dual transmission is applied with a plurality of first channels and a plurality of second channels in the DBCC environment. In step S104, the BA reports are monitored during data transmission. The back-off mechanism is part of the medium access control (MAC) protocol. The BA reports help manage channel access to avoid data collisions when multiple nodes transmit data simultaneously. When multiple nodes contend for the channel, they use back-off algorithms to determine when to transmit, thus ensuring efficient channel utilization in wireless networks, and providing adaptive approaches to enhance performance.

In step S106, the plurality of first channels are assigned as primary channels and the plurality of second channels are assigned as secondary channels when overall connectivity quality of the plurality of first channels is better than overall connectivity quality of the plurality of second channels. In an embodiment, the overall connectivity quality is determined by the monitored BA reports when transmitting data. In step S108, after the overall connectivity quality is determined, whether the data to be transmitted is critical or not is checked; if the data to be transmitted is critical, go to step S110; else, go to step S112. In step S110, the data is transmitted based on the replication policy. Under the replication policy, since the data is critical, the data is transmitted simultaneously through both the primary channels and the secondary channels to avoid missing any part of the data. In step S112, whether the communication data errors of the data to be transmitted need to be reduced or not is checked; if the communication data errors of the data to be transmitted need to be reduced, go to step S114; else, go to step S116. In step S114, the data is transmitted based on the dynamic channel allocation policy. Under the dynamic channel allocation policy, the data to be transmitted is allocated to the primary channels and the secondary channels based on required communication error rates. The data requiring a low communication error rate is allocated to the primary channels, and the data requiring a high communication error rate is allocated to the secondary channels. In step S116, the data is transmitted based on the splitting policy. Under the splitting policy, the data to be transmitted is allocated to the primary channels and the secondary channels according to data types of the data. In an embodiment, video packets of the data are allocated to the primary channels and audio packets of the data are allocated to the primary channels and secondary channels.

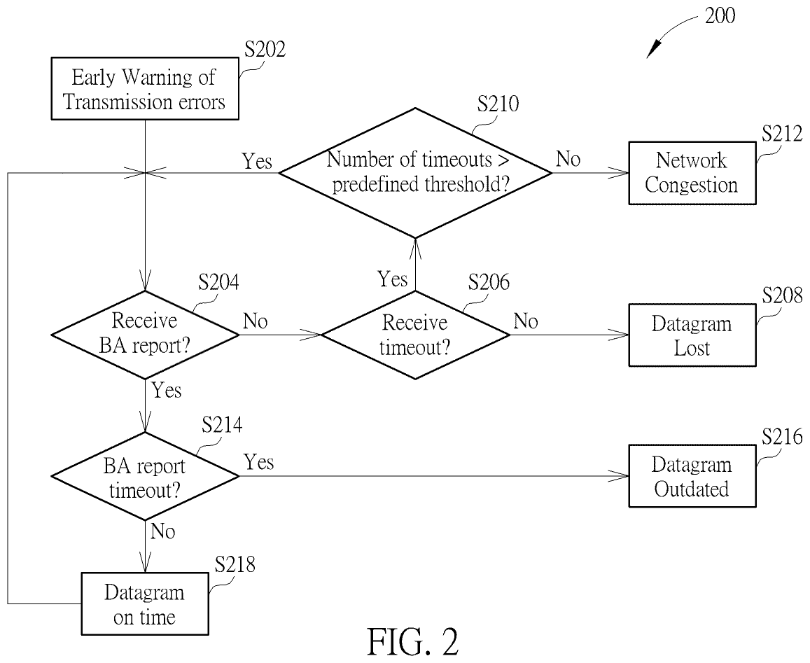

In addition to managing channel access to avoid data collisions when multiple nodes transmit data simultaneously, the BA reports can be used to determine network status of a wireless communication system. FIG. 2 is a flowchart of a transmission error detection method 200 in a wireless communication system according to an embodiment of the present invention. The transmission error detection method 200 includes the following steps:
Step S202: receive early warning of transmission errors;
Step S204: check whether a BA report has been received; if so, go to step S214; else, go to step S206;
Step S206: check whether a timeout has been received; if so, go to step S210; else, go to step S208;
Step S208: determine a datagram has been lost.
Step S210: check whether the number of timeouts is larger than a predefined threshold; if so, go to step S212; else, go to step S204;
Step S212: determine the network is congested.
Step S214: check whether the BA report is received after timeout; if so, go to step S216; else, go to step S218;
Step S216: determine a datagram is outdated.
Step S218: determine a datagram has been received on time; go to step S204.

In step S202, early warning of transmission errors is received. In step S204, whether a BA report has been received or not is checked; if the BA report has been received, go to step S214; else, go to step S206. In step S206, whether a timeout has been received or not is checked; if the timeout has been received, go to step S210; else, go to step S208. In step S208, a datagram is determined to be lost. In step S210, whether the number of timeouts is larger than a predefined threshold or not is checked; if the number of timeouts is larger than a predefined threshold, go to step S212; else, go to step S204; In step S212, the network is determined to be congested. In step S214, whether the BA report is received after timeout or not is checked; if the BA report is received after timeout, go to step S216; else, go to step S218. In step S216, a datagram is determined to be outdated. In step S218, the datagram is determined to have been received on time, and go to step S204. In an embodiment, a timeout mechanism is implemented at a transmitter side to regulate a data transmission process based on received BA reports. The timeout mechanism is performed according to whether a datagram has been lost, a network is congested or a datagram is outdated.

The embodiment of present invention aims to enhance network reliability by proactively identifying and swiftly resolving transmission issues. By monitoring BA report timeouts and implementing sender-side timeouts, the system can promptly detect potential errors, such as network congestion or packet losses. Additionally, by promptly handling outdated datagrams, the system can initiate retransmissions or error recovery procedures, minimizing the impact of transmission errors on overall communication. The accompanying diagram visually depicts the proposed methodology, illustrating the interaction among the back-off mechanism, BA monitoring, report and timeout implementations at both the sender and receiver ends. This visual aid offers a clear overview of the error detection and handling processes, enhancing understanding of the system's operation.

To mitigate transmission errors, various approaches are employed. Some involve sending duplicate data multiple times, and others utilize redundant data, such as forward error correction (FEC) codes specified in Bluetooth (BT) standards. While existing techniques effectively address single points of failure, practical scenarios often involve persistent transmission errors over time, affecting consecutive packets. In such cases, conventional methods may not provide sufficient error protection. The present invention introduces an alternative transmission technique capable of handling prolonged transmission errors. Instead of merely retransmitting the same data frame, this approach offers improved reliability.

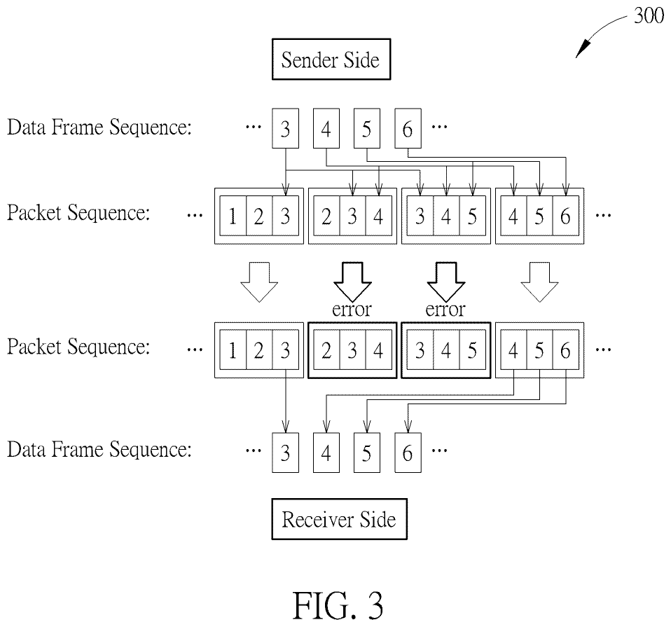

To mitigate persistent transmission errors affecting consecutive packets, the embodiment of the present invention incorporates a distribution_step that disperses the same data frame among non-consecutive packets as shown in FIG. 3. When setting the distribution_step to N, the application distributes the same data frame to every Nth packet. FIG. 3 is a schematic diagram of the distribution_step method 300 according to an embodiment of the present invention. In an embodiment, N is 3. Data frames 1, 2, 3 are distributed in a first packet, and data frames 2, 3, 4 are distributed in a second packet. Data frames 3, 4, 5 are distributed in a third packet, and data frames 4, 5, 6 are distributed in a fourth packet. In FIG. 3, an error occurs when transmitting the second packet and the third packet. However, data frames 2, 3 can be found in the first packet, and data frames 4, 5 can be found in the fourth packet. Therefore, the data frames 1, 2, 3, 4, 5, 6 can all be obtained on the receiver side by applying the distribution_step.

In the present invention, even if three consecutive packets are corrupted during transmission, the receiver can still recover the data frame from the remaining packets. By distributing the same data frame across non-consecutive packets, the proposed technique enhances the overall reliability of the communication system, providing resilience against persistent transmission errors over time. The utilization of a distribution_step effectively decouples the interdependence of consecutive packets, ensuring that the loss of multiple consecutive packets does not lead to the complete loss of a data frame. The embodiment of the present invention proves especially valuable in scenarios where transmission errors are prone to occur in bursts, such as wireless or lossy environments, thereby enhancing the overall robustness and error resilience of the communication mechanism.

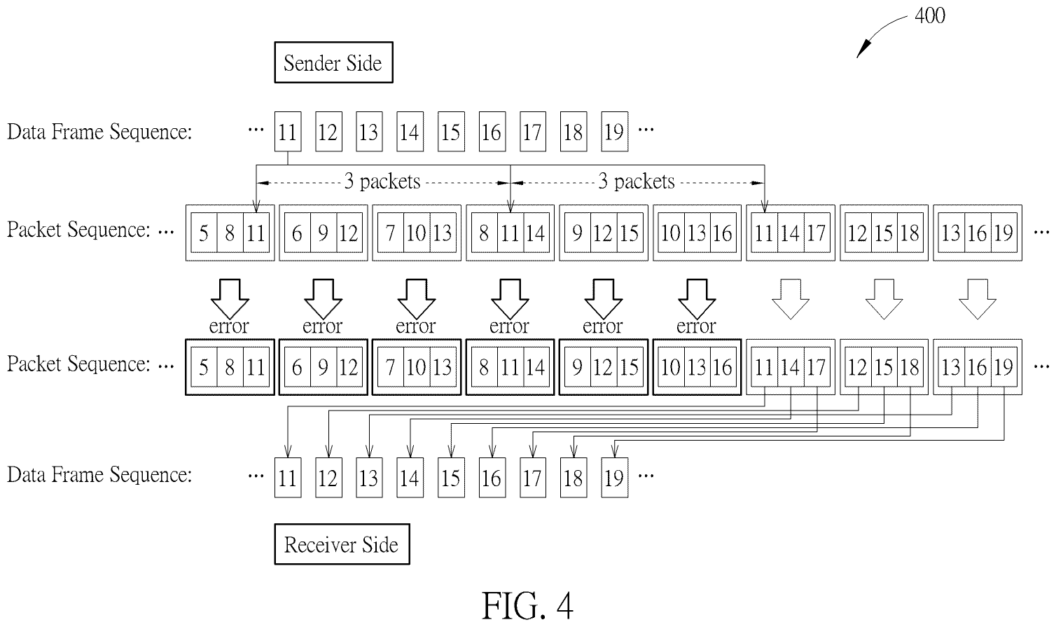

FIG. 4 is a schematic diagram of the distribution_step method 400 according to another embodiment of the present invention. In FIG. 4, three data frames are allocated in a packet, and the second data frame in the packet is also allocated in the third previous packet and the third subsequent packet. For example, data frames 5, 8, 11 are allocated in a first packet, and data frames 6, 9, 12 are allocated in a second packet. Data frames 7, 10, 13 are allocated in a third packet, and data frames 8, 11, 14 are allocated in a fourth packet. Data frames 9, 12, 15 are allocated in a fifth packet, and data frames 10, 13, 16 are allocated in a sixth packet. Data frames 11, 14, 17 are allocated in a seventh packet, and data frames 12, 15, 18 are allocated in an eighth packet. Data frames 13, 16, 19 are allocated in a ninth packet. Each data frame is allocated in three non-consecutive packets in order to provide resilience against persistent transmission errors over time, thereby enhancing the overall reliability of the communication system.

In FIG. 4, a consecutive error occurs due to lossy environment, and the first, second, third, fourth, fifth, sixth packets are all corrupted in a transmission. However, data frames 11, 12, 13, 14, 15, 16, 17, 18, 19 can be found in the seventh, eighth, ninth packets, and data frames 5, 6, 7, 8, 9, 10 can be found in previous packets. As shown in FIG. 4, the proposed technique significantly enhances the tolerance for consecutive transmission errors by distributing the same data frame across non-consecutive packets. By carefully configuring the distribution_step to align with the characteristics of different communication environments, the distribution_step method effectively mitigates the impact of persistent transmission errors occurring over time.

The primary advantages of this method stem from its ability to decouple the interdependence of consecutive packets and provide resilience against burst errors that may corrupt multiple packets in succession. By strategically distributing redundant data across the packet stream, the receiver can recover the original data frame even when faced with localized error bursts, thereby enhancing the overall reliability and robustness of the communication system.

Furthermore, the ability to fine-tune the distribution_step parameter enables customization of the technique to suit specific application requirements and environmental conditions. In an embodiment, N is 3 but not limited to 3. For instance, in error-prone environments, a smaller distribution_step can enhance redundancy and error tolerance, while in more stable conditions, a larger value optimizes bandwidth utilization. In summary, the present invention offers a practical and adaptable solution for addressing the challenge of persistent transmission errors, which is a limitation often encountered in real-world communication scenarios.

In conclusion, the present invention provides a wireless communication method in a DBCC environment, a transmission error detection method in a wireless communication system, and a distribution_step method in a lossy communication environment. These methods enhance wireless communication in a complicated environment by applying various policies with the primary channels and the secondary channels, implementing timeout mechanism with transmission error detection, and performing distribution_step to avoid persistent transmission errors.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method in a Dual Band Concurrent Connectivity (DBCC) environment, comprising:
assigning a plurality of first channels as primary channels and a plurality of second channels as secondary channels when overall connectivity quality of the plurality of first channels is better than overall 1 connectivity quality of the plurality of second channels;
simultaneously transmitting critical data frames over the primary channels and the secondary channels;
when data is to be transmitted with reduced communication errors, and the data is not critical, allocating the data to the primary channels and the secondary channels based on required communication error rates; and
when data is to be transmitted without reduced communication errors, and the data is not critical, allocating the data to the primary channels and the secondary channels according to data types of the data.

2. The method of claim 1, wherein allocating the data to the primary channels and the secondary channels based on the required communication error rates is allocating data requiring a low communication error rate to the primary channels, and data requiring a high communication error rate to the secondary channels.

3. The method of claim 1, wherein allocating the data to the primary channels and the secondary channels according to the data types of the data is allocating video packets of the data to the primary channels and audio packets of the data to the primary channels and the secondary channels.

4. The method of claim 1, further comprising:
transmitting data packets, each data packet comprising N data frames, each data frame being embedded in N data packets;
wherein N is a positive integer.

5. The method of claim 4, wherein the N data frames are consecutive data frames.

6. The method of claim 4, wherein each of first (N−1) data frames of the N data frames is separated from next by N data frames.

7. The method of claim 1, further comprising comparing the overall connectivity quality of the plurality of first channels and the overall connectivity quality of the plurality of second channels according to back-off mechanism acknowledgement reports.

8. A transmission error detection method in a wireless communication system, comprising:
monitoring back-off mechanism acknowledgement (BA) reports during data transmission;
when an expected BA report is not received and a timeout is not received, determining a transmission error has occurred;
when not receiving a predetermined number of expected BA reports consecutively while receiving the predetermined number of timeouts consecutively, determining a network is congested; and
when a BA report is received after timeout, determining received data is outdated.

9. The method of claim 8, further comprising implementing a timeout mechanism at a transmitter side to regulate a data transmission process based on received BA reports.

10. The method of claim 9, wherein implementing the timeout mechanism comprises transmitting data packets, each data packet comprising N data frames, each data frame being embedded in N data packets;
wherein N is a positive integer.

11. The method of claim 10, wherein the N data frames are consecutive data frames.

12. The method of claim 10, wherein each of first (N−1) data frames of the N data frames is separated from next by N data frames.
